(19) United States
(12) Patent Application Publication
(10) Pub. No.: US 2004/0037493 A1
(43) Pub. Date: Feb. 26, 2004

(54) Optical signal processing apparatus based on movable tilted reflection mirror

(75) Inventors: Chongkuo Lee, Taipei (TW); Yan-Jyh Lai, KaoHsiung (TW)

Correspondence Address: BRUCE H. TROXELL, SUITE 1404, 5205 LEESBURG PIKE, FALLS CHURCH, VA, 22041, US

(73) Assignee: Asia Pacific Microsystems, Inc.

(21) Appl. No.: 10/645,488

(22) Filed: Aug. 22, 2003

(30) Foreign Application Priority Data
Aug. 23, 2002 (TW) 91119074

(51) Int. Cl. G02B 6/35; G02B 6/26

(52) U.S. Cl. 385/18; 385/140

(57) ABSTRACT

An optical signal processing apparatus based on movable tilted reflection mirror comprises a movable tilted reflection mirror unit and a micro actuator. The micro actuator is used to control and actuate the relative location and position of the movable reflection mirror unit with respect to the optical transmission path of light signals. To control the light intensity of the incoming optical signals being reflected toward output ports and the light intensity of the optical signals transmitted forward to output ports, the light intensity is adjusted in terms of the location of the movable tilted reflection mirror unit which is determined by electrically controlling said micro-actuator. The movable tilted reflection mirror unit comprises at least one reflective mirror plane, which can be a flat mirror plane, a shaped mirror plane, or a curved mirror plane. A plurality of such optical processing apparatuses can be integrated to form an optical signal processing apparatus with the function of variable optical attenuation, optical switching, optical multiplexing/demultiplexing, and optical add/drop.

### 1. FIELD OF THE INVENTION

The present invention relates to an optical signal processing apparatus based on movable tilted reflection mirror, providing the function to control the optical signal intensity in the optical transmission path. In particular, the present invention relates to an optical signal processing apparatus with the function of multiple channel processing, which is composed of several the said optical signal processing apparatuses to control the optical signal intensity regarding to each channels of multiple channels, add the optical signal switching among different channels of multiple channels, further achieving the object of multiplexing/demultiplexing, adding/dropping optical signals for optical Add/Drop Multiplexer (OADM) application.

### 2. BACKGROUND OF THE INVENTION

For the great progress of optical communication in the present day, a all-optical network, an telecommunication network without using architecture and systems based on optic-electric (OE) and electro-optic (EO) convertion technology, is becoming the main stream of the telecommunication system. Therefore, in the optical communication system, it is necessary to directly deal with the optical signals, such as to dynamically control the intensity of optical signals and to switch the optical signals between the different optical paths. Wherein, to dynamically control the intensity of optical signals, a multi-channel optical attenuator is indispensable that can be used to maintain the quality of optical signals in processing and protect the relative active and the passive elements in the optical communication system, and even to achieve the object of system simplification; and to switch the optical signals between the different optical transmission paths, a multi-channel optical switching apparatus is necessary. Besides, in the optical communication network, at each node, it is usually required to switch multiple wavelength signals into different optical transmission paths, to delete some signals from a multiple wavelength signal, or to add some signals into a multiple wavelength signal. Therefore, an optical signal processing apparatus with high quality and low cost has played an important role in the fiber optic communication system.

Most traditional mechanical optical switches and variable optical attenuators are still using the traditional mechanical stricture as the switching mechanism, of which many disadvantages are inevitable, such as larger size, higher energy-consuming, more complex manufacturing and so on. To solve the aforesaid problems, the MicroElectroMechanical system (MEMS) technology has been applied to in the fabrication of the optical switches and the variable optical attenuators. Such technology not only can largely reduce the device size, but also can carry out the mass production as in the semiconductor manufacturing. Presently, the commonest structure of the MEMS variable optical attenuator is based on the shuttered structure, which is specifically described as follows:

1) Please refer to FIG. 1, which is a schematic view of a variable optical attenuator according to an embodiment of O'Keefe's invention (U.S. Pat. No. 6,246,826). As shown in FIG. 1, the variable optical attenuator comprise an input optical fiber 121, an output optical fiber 122, two ball lens 123 and 124, and an attenuator 125 which comprises an actuator 126 and a shutter 127. With a Comb drive or other actuation methods, the actuator 126 will carry the blade 127 to be horizontally moveable between the input optical fiber 121 and the output optical fiber 122 so as to partially block the light and provide the attenuation of the optical signals.

2) Please refer to FIG. 2, which is a schematic view of an optical attenuator of Aksyuk's invention (U.S. Pat. No. 6,173,105). As shown in FIG. 2, a variable optical attenuator comprises an input fiber 131, an output fiber 132, and an optical attenuator that includes a shutter 133 and an actuator. Wherein, the actuator further comprises a pair of spaced poly-silicon plates, the upper plate 134 and the lower plate 135, to form a capacitor; the shutter 133 is connected to the upper plate 134 through a level aim 136, which is an extension of the upper plate 134 of the voltage-controlled actuator formed by the two spaced poly-silicon plates 134, 135. The downward movement of the plate 134 is made to cause upward movement of the shutter 133. When the shutter 133 is activated by applying sufficient voltage to the actuator, it is moved to interrupt this gap region so as to obtain the attenuation of the optical signals.

Obviously, the major mechanism of both the apparatuses in the aforesaid U.S. patents is to interrupt the optical signals in the free space when the signals are transmitting. However such structure still suffers some problems, such as the larger back reflection and the larger polarization dependent loss (PDL). The major structure of such shutter type variable optical attenuators comprises a shutter located at ends of two fibers with the two opposite terminal faces. When an optical signal is transmitted from the end of one fiber and is going to couple into the end of the other fiber through the free space, the shutter is used to stretch into the gap between the two ends of the fibers to block partial optical signals. As the position of the shutter is varied, the blocked amount of the optical signals will be varied, and thus the extent of the optical attenuation can be controlled. To avoid the insertion loss (IL) being enlarged when optical signals are coupling into the fiber, the gap between the two ends of the fibers cannot be too large; generally, if the distance between the two ends of the fibers is 20 um˜35 um, the IL will be less than 1 db; however such distant is so short that the blocked signals are easily reflected and coupled into the input end, which will result in too much back reflection, damaging the active elements over a long period of time. Under such situation, the common solution is to add an optical isolator in front of the end of the fiber so as to eliminate the phenomenon of the back reflection. However, such method will also cause the extra optical signal insertion loss and increase the cost.

On the other hand, the major reason of the larger polarization dependent loss (PDL) in the said shuttered variable optical attenuator is that the front edge profile of the shaped shutter is rugged and will cause the local diffraction. The larger PDL may result in the signal distortion after a long distant transmitting.

Based on the similar optical transmission structure, the present invention introduces a movable reflection mirror instead of the aforesaid shutter to obtain the optical attenuation. When the optical signals are transmitted from the end of a fiber, entering into the free space, the movable reflection mirror can be used to reflect such optical signals and couple them into the receiving end of the other fiber regarding to output ports. By adjusting the position of the reflection mirror, the attenuation range is determined by controlling the percentage of reflected light intensity coupled into the output fiber. In such structure, the attenuated optical signals are reflected away from the optical elements rather than coupled into the input fiber, so the amount of the back reflection will be largely reduced. Furthermore, instead of the structure of the shuttered variable optical attenuator, the reflective structure of the present invention can even diminish the PDL.

### SUMMARY OF THE INVENTION

The primary object of the present invention is to provide an optical signal processing apparatus based on movable tilted reflection mirror, which is characterized by low back reflection, low insertion loss, low polarization dependent loss, small size, simple fabrication and so on.

A movable tilted reflection mirror unit of the present invention disclosed the optical signal processing apparatus based on movable tilted reflection mirror is provided to change the optical transmission paths in the free space so as to adjust the coupled light intensity from input channel to output channel via controlling the relative position of tilted reflection mirror in terms of controlling the micro actuator The aforesaid optical signal processing apparatus based on movable tilted reflection mirror can be fabricated by using the MicroElectroMechanical system (MEMS) technology, and the movable tilted reflection mirror unit comprises at least a reflective mirror plane and a micro actuator, and the reflective mirror plane can be composed of various optical elements.

The movable tilted reflection mirror unit is located at the optical transmission path, and can make the input optical signals be reflected at least once, coupling them into the output terminal. An independent micro actuator is provided to connect with the movable tilted reflection mirror unit. A relative control driver is provided to modulate the position of the micro actuator so as to indirectly control the position of the movable tilted reflection mirror unit and to change the optical transmission paths, achieving the function of variable optical attenuation and optical switching.

On the basis of the function of variable optical attenuation and optical switching, the present invention further can integrate with multiplexer and demultiplexer to form an optical signal processing apparatus with the function of variable optical attenuation, optical switching, optical multiplexing/demultiplexing, and optical add/drop.

### BRIEF DESCRIPTION OF THE DRAWINGS

FIG. 1 is a schematic view of a variable optical attenuator according to an embodiment of U.S. Pat. No. 6,246,826.

FIG. 2 is a schematic view of an optical attenuator of U.S. Pat. No. 6,173,105.

FIGS. 3A to 3D are respectively the schematic views showing the first mode, the second mode, the third mode, and an array layout of the first embodiment of the present invention.

FIGS. 4A and 4B are respectively the schematic views showing the first and the second mode of the second embodiment of the present invention.

FIG. 4C is the schematic view of the second embodiment of the present invention, showing the relative angles between the MEMS reflective unit and the input fiber as well as the output fiber.

FIG. 4D is the schematic view showing the first mode, the second mode, and the third mode of the reflective mirror planes in the second embodiment of the present invention.

FIG. 5 is a schematic view showing the third embodiment of the present invention.

FIGS. 6A and 6B are the schematic views showing the first mode of the fourth embodiment of the present invention.

FIGS. 7A and 7B are the schematic views showing the second mode of the fourth embodiment of the present invention.

FIGS. 8A and 8B are the schematic views showing the third mode of the fourth embodiment of the present invention.

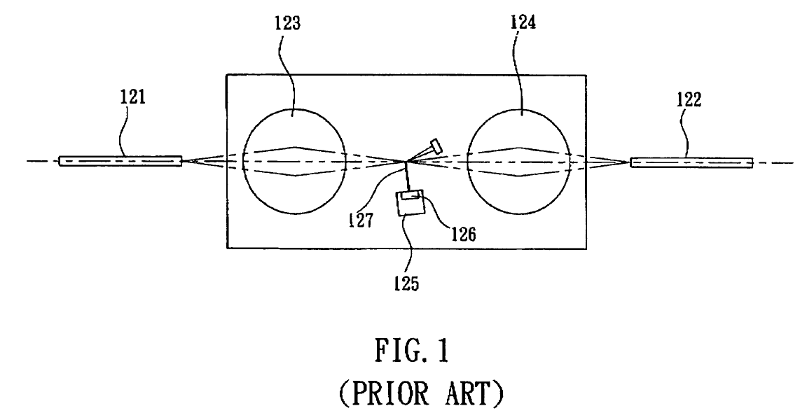

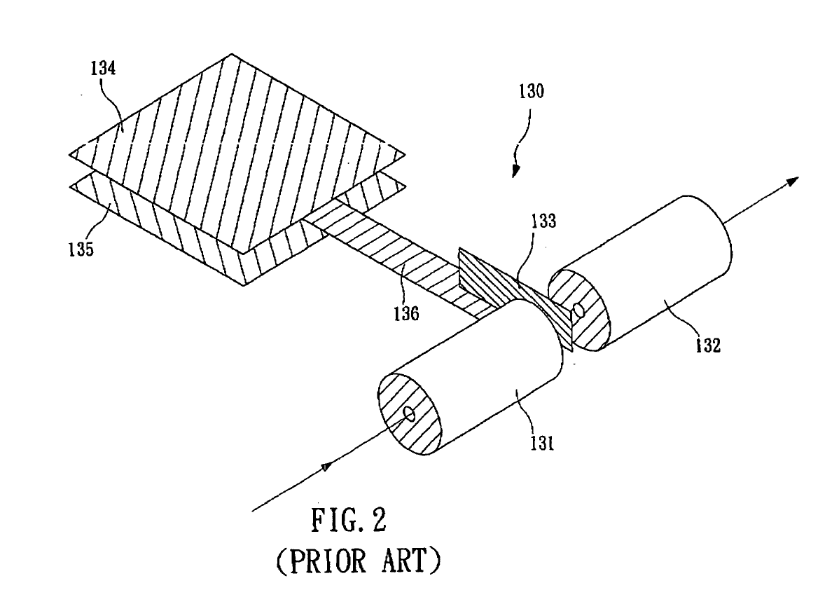

### DETAILED DESCRIPTION OF THE INVENTION

Matched with corresponding drawings, the preferable embodiments of the invention are presented as following and hope they will benefit your esteemed reviewing committee members in reviewing this patent application favorably.

The First Embodiment

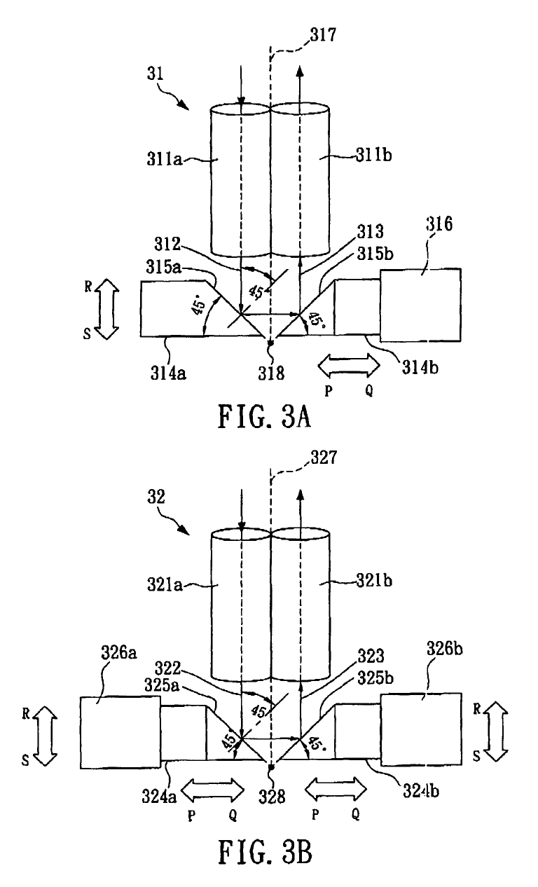

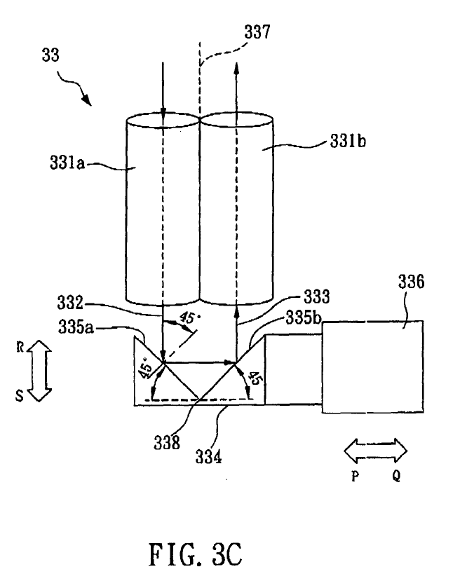

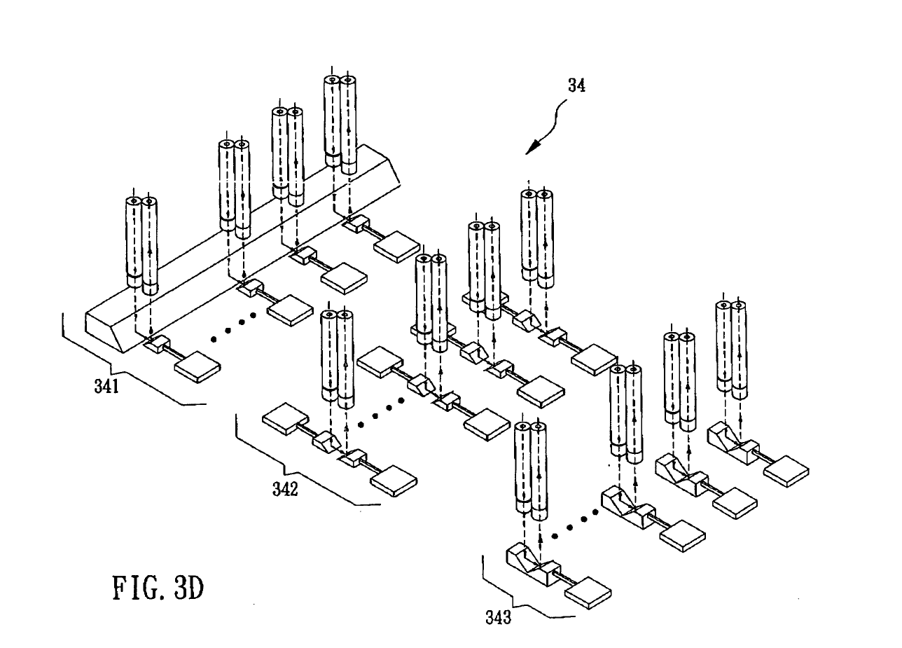

FIGS. 3A, 3B, 3C, and 3D are respectively the schematic views of the first mode, the second mode, the third mode, and the array layout of the first embodiment of the present invention.

As shown in FIG. 3A, the first mode the optical signal processing apparatus based on movable tilted reflection mirror 31 includes a set of parallel fibers, a fixed reflection mirror unit, and a movable tilted reflection mirror unit. Wherein the set of parallel fibers comprises an input fiber (or a plane optical waveguide) 311a and an output fiber (or a plane optical waveguide) 311b, which are respectively used to accept an incident optical signal 312 and to output a reflected optical signal 313. The fixed reflection mirror unit comprises a first plane 314a and a first reflective mirror plane 315a, and the included angle between the two planes 314a, 315a is 45°. The movable tilted reflection mirror unit comprises a second plane 314b and a second reflective mirror plane 315b; wherein the second plane 314b is parallel to the first plane 314a, and the included angle between the two planes 314b, 315b is 45°. A micro actuator 316 is provided to actuate the movable tilted reflection mirror unit along the direction of PQ and RS to fine tune the position of the reflected optical signal 313 so as to modulate the intensity of the optical signal 311b that is going to couple to the output fiber. Thus the function of variable optical attenuation can be obtained of the optical signal processing apparatus based on movable tilted reflection mirror 31. Another possible mechanism of the first mode is that the fixed reflection mirror unit and the movable tilted reflection mirror unit are respectively located at the position of the reflected optical signal 313 and that of the incident optical signal 312; a micro actuator 316 is provided to actuate the movable tilted reflection mirror unit, the combination of the first plane 314a and the first reflective mirror plane 315a, to fine tune the first reflective mirror plane 315a so as to change the position of the incident optical signal 312 and thus to modulate the intensity of optical signals from the output fiber 311b, obtaining the function of variable optical attenuation of the optical signal processing apparatus based on movable tilted reflection mirror 31, too.

As shown in FIG. 3B, the second mode of the optical signal processing apparatus based on movable tilted reflection mirror 32 includes a set of parallel fibers, a first movable tilted reflection mirror unit, and a second movable tilted reflection mirror unit. Wherein the set of parallel fibers comprise an input fiber (or a plane optical waveguide) 321a and an output fiber (or a plane optical waveguide) 321b, which are respectively used to accept an incident optical signal 322 and output a reflected optical signal 323. The first movable tilted reflection mirror unit comprises a first plane 324a and a first reflective mirror plane 325a, and the included angle between the two planes 324a, 325a is 45°; a micro actuator 326a is provided to actuate the movable tilted reflection mirror unit along the direction of PQ and RS. The second movable tilted reflection mirror unit comprises a second plane 324b and a second reflective mirror plane 325b, wherein the second plane 324b is parallel to the first plane 324a, and the included angle between the two planes 324b, 325b is 45°; a micro actuator 326b is provided to actuate the movable tilted reflection mirror unit along the direction of PQ and RS. The first reflective mirror plane 325a and the second reflective mirror plane 325b can be actuated by the relative micro actuators 326a, 326b individually, successively, or simultaneously so as to fine tune the positions of the incident optical signal 322 and the reflected optical signal 323 individually, successively, or simultaneously. Thus the function of variable optical attenuation can be achieved of the optical signal processing apparatus based on movable tilted reflection mirror 32.

As shown in FIG. 3C, the third mode of the optical signal processing apparatus based on movable tilted reflection mirror 33 includes a set of parallel fibers, and a movable tilted reflection mirror unit. Wherein the set of parallel fibers comprise an input fiber (or a plane optical waveguide) 331a and an output fiber (or a plane optical waveguide) 331b, which are respectively used to accept an incident optical signal 332 and output a reflected optical signal 333. The movable tilted reflection mirror unit comprises a first plane 334, a first reflective mirror plane 335a and a second reflective mirror plane 335b. The first reflective mirror plane 335a and the second reflective mirror plane 335b are perpendicular to one another, and are actuated by a same micro actuator 336 along arbitrary direction to fine tune both the positions of the incident optical signal 332 and the reflected optical signal 333 so that the function of variable optical attenuation can be obtained of the optical signal processing apparatus based on movable tilted reflection mirror 33.

The aforesaid first mode, second mode and third mode of the first embodiment can be sorted respectively as a single movable tilted reflection mirror, a pair movable tilted reflection mirror s, and a movable tilted reflection mirror. There are at least three common characters of such three modes:

1) The first reflective mirror planes and the second reflective mirror planes are perpendicular to one another.

2) It only requires a single orientation step to complete the orientation of the whole optical signal processing apparatus based on movable tilted reflection mirror. To take the first mode of FIG. 3A for example, the only orientation step is to make a center line of the set of parallel fibers (or a center line of plane waveguide) 317 be perpendicular to the first plan 314a, aiming at a bottom line 318 that is the intersected line of the first reflective mirror plane 315a and the second reflective mirror plane 315b. As shown in FIG. 3A, the incident optical signal 312 is transmitted into the first reflective mirror plane 315a with the incident angle 45° and then reflected to the second reflective mirror plane 315b with the same incident angle 45°; and then further reflected to become, the reflected optical signal 313 with a reflected angle 45′. In the ideal status, the reflected optical signal 313 can be outputted from the output fiber 311b at the best coupling state. Similarly, as shown in FIGS. 3B and 3C, the center lines of the second mode and the third mode 327, 337 are respectively perpendicular to the first plan 324a, 334a, aiming at a bottom line 328, 228 that are the intersected lines of the first reflective mirror plane 325a, 335a and the second reflective mirror plane 325b, 335b. It can be further installed a light source and a signal detector (not shown in the figures) respectively on the input terminals of the input fibers 311a, 321a, 331a and the output terminals of the output fibers 311b, 321b, and 331b to assist the orientation. Moreover, the foregoing orientation step is not the only orientation method. All the methods that are able to make optical signals be transmitted from the output fiber can all be adopted. For example, another orientation method is to make a plane, which is defined by the incident optical signals 312, 322, 332 and the reflected optical signals 313, 323, and 333, perpendicular to the first plane 314a, 324a, 334a; then to adjust the relative position between the set of the parallel fibers and the first reflective mirror planes 315a, 325a, 335a as well as the second reflective mirror planes 315b, 325b, 335b, making the distant from the incident optical signals 312, 322, 332 to the reflected optical signals 313, 323, 333 equal to the distant from the axle center of the input fiber 311a, 321a, 331a to the axle center of the output fiber 311b, 321b, and 331b; and thus the other single orientation step is completed.

3) By adjusting the position of the incident optical signals (such as the first and the second mode), adjusting the position of the reflected optical signals (such as the first and the second mode), adjusting the position of the incident optical signals and the reflected optical signals in turn (such as the second mode), or adjusting the position of the incident optical signals and the reflected optical signals simultaneously (such as the second and the third mode), the aforesaid three modes all can obtain the function of variable optical attenuation of the optical signal processing apparatus based on movable tilted reflection mirror.

In addition, the aforesaid three modes of the first embodiment have the following advantages:

1) It only requires one step for orientation before packaged, as described in the aforesaid second character.

2) After packaged, the element orientation inaccuracy caused by the variant factors in manufacture process still can be compensated by fine tuning the position of the reflection mirror so that the quality aid yield of the products can be improved. In prior arts, except the reflection mirror, all other elements cannot be adjusted after packaged; moreover, the static tilted angle of such reflection mirror is too sensitive to be controlled for high attenuating resolution.

3) The expansibility is mach higher. FIG. 3D is the schematic views of the array layout of the first embodiment in the present invention. As shown in FIG. 3D, the optical signal processing apparatus based on movable tilted reflection mirror 34 comprises a first row 341, a second row 342, and a third row 343, which are respectively showing the first mode, the second mode, and the third mode. Besides such three modes, basing on the different requirements, we can regularly or arbitrarily arrange several individual aforesaid apparatuses to form a multi-channel telecommunication optical signal processing apparatus based on movable tilted reflection mirror with the function of variable optical attenuation.

The Second Embodiment

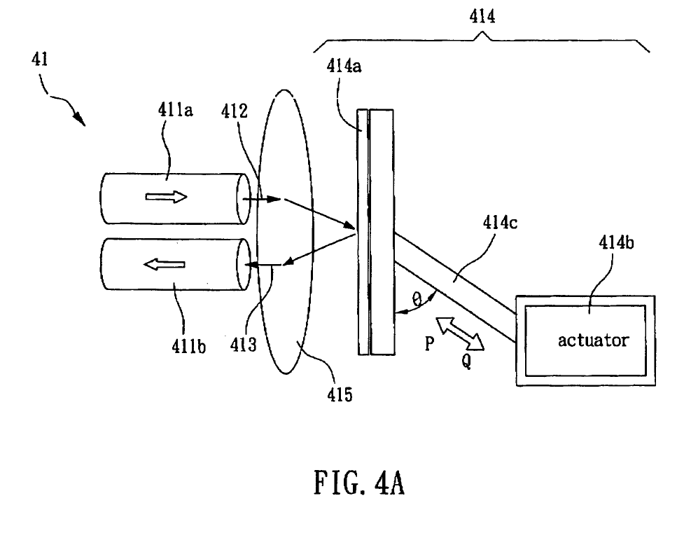

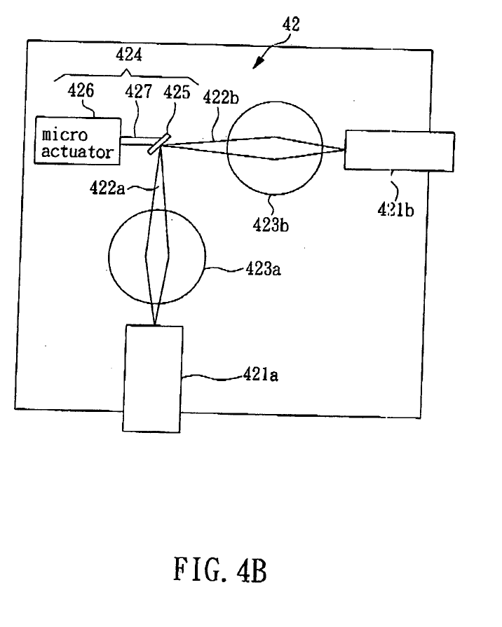

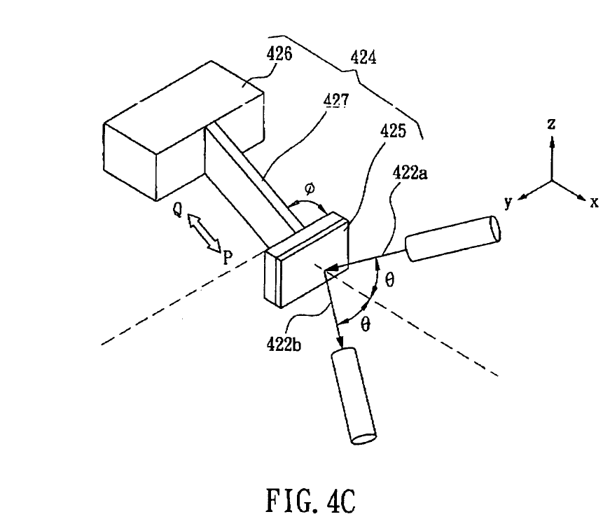

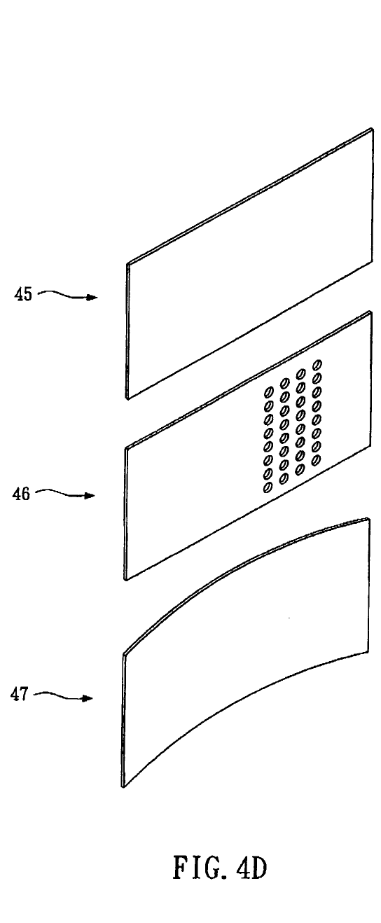

FIGS. 4A and 4B are respectively the first mode 41 and the second mode 42 of the second embodiment of the present invention.

As shown in FIG. 4A, the first mode of the second embodiment of the present invention includes a set of parallel fibers, a MicroElectroMechanical system (MEMS) reflective unit 414, and a refraction element 415 with the focus function. Wherein the set of parallel fibers comprise an input fiber (or a plane optical waveguide) 411a and an output fiber (or a plane optical waveguide) 411b, which are respectively used to accept an incident optical signal 412 and output a reflected optical signal 413. The MEMS reflective unit 414 comprises a reflective mirror plane 414a and a micro actuator 414b, which can actuate the reflective mirror plane 414a along the direction of PQ through a connecting rod 414c; the included angle between the connecting rod 414c and the reflective mirror plane 414a is θ, of which the range is 0°˜90°. The incident optical signals 412 are refracted by the refraction element 415 and then reflected by the reflective mirror plane 414a, further refracted by the refraction element 415 again and outputted finally from the output fiber 411b under the best coupling state in ideal status. The micro actuator 414b is provided to actuate the reflective mirror plane 414a so as to fine tune the position of the reflected optical signal 413; thus, the variable optical attenuator of the first mode 41 in the second embodiment can be completed.

Moreover, as shown in FIG. 4B, in the second mode of the second embodiment of the present invention, an input optical signal from an input fiber 421a is refracted by a first refraction element 423a and thus become an incident optical signal 422a; then the optical signal 422a is reflected by a reflective mirror plane 425 of the MEMS reflective unit 424 to become an reflected optical signal 422b, which is refracted by a second refraction element 423b and finally outputted from a output fiber 421b. Wherein the MEMS reflective unit 424 further comprises a micro actuator 426 and a connecting rod 427; the micro actuator 426 can actuate the reflective mirror plane 425 with the connecting rod 427 to change the path of the reflective optical signals and control the intensity of the optical signal that is going to couple to the output fiber 421b so as to obtain the function of optical attenuation and optical switching.

FIG. 4C further illustrates the MEMS reflective units 414, 424 of FIG. 4A and FIG. 4B. As shown in FIG. 4C, a x-y-z coordinate is labeled. A reflective mirror plane 425 is located in the y-z plane, and an included angle φ (0°<φ<90°) between the connecting rod 427 and the reflective mirror plane 425 is provided. The incident angle of an incident optical signal 422a and the reflective angle of a reflected optical signal 422b are both θ (0°<θ<90°). When the reflective mirror plane 425 is actuated by a micro actuator 426 through the connecting rod 427 and moves lone the axle direction of the connecting rod 427 (the PQ direction) so as to execute the function of optical attenuation and optical switching, the incident angle θ, the reflective angle θ, and the included angle φ will all keels constant.

FIG. 4D is the schematic view of the first mode 45, the second mode 46, and the third mode 47 of the reflective mirror planes 414a, 425 in the second embodiment of the present invention, which are respectively a flat mirror plane, a shaped mirror plane, and a curved mirror plane. Wherein, the shaped mirror plane means that some variant patterns, materials, or holes are formed on a flat mirror plane in order to reduce the reflectivity of such areas. Based on the density of the pattern distribution, the gradient of reflectivity can be adjusted. Moreover, the reflectivity can also be adjusted by covering the variant thin films; when the reflective mirror plane is moved, the intensity of the reflected optical signals will be varied because of the different reflectivity so that the function of variable optical attenuation can be achieved. The curved mirror plane can cause the different reflective directions due to the different variance of curvature gradient. When the curved mirror plane is moved, the direction of the reflected optical signals will also be changed so as to modulate the intensity of the optical signals that is going to couple to the output fiber. The aforesaid shaped mirror plane and curved mirror plane both can be replaced respectively by the optical reflective mirror units with variant surface reflectivity and with variant surface reflective directions. If the angle θ and the angle φ are equal to zero simultaneously, the reflective mirror plane (in FIG. 4A) will only reciprocate alone the plane defined thereby. So the shaped mirror plane of the second mode 46 as well as the curved mirror plane of the third mode 47 can be used to obtain the same function the variable optical attenuation of the optical signal processing apparatus based on movable tilted reflection mirror 41.

In practice, all the reflective mirror planes of the present invention can be the arbitrary modes of FIG. 4D in the second embodiment.

A plurality of the first modes 41 and second modes 42 of the second embodiment in the present invention can be arranged into a single or a plurality mirror structure to form a multi-channel variable optical attenuator or to be a telecommunication element applied in a one-to-multi optical switch, and can further be used in the optical communication network.

The Third Embodiment

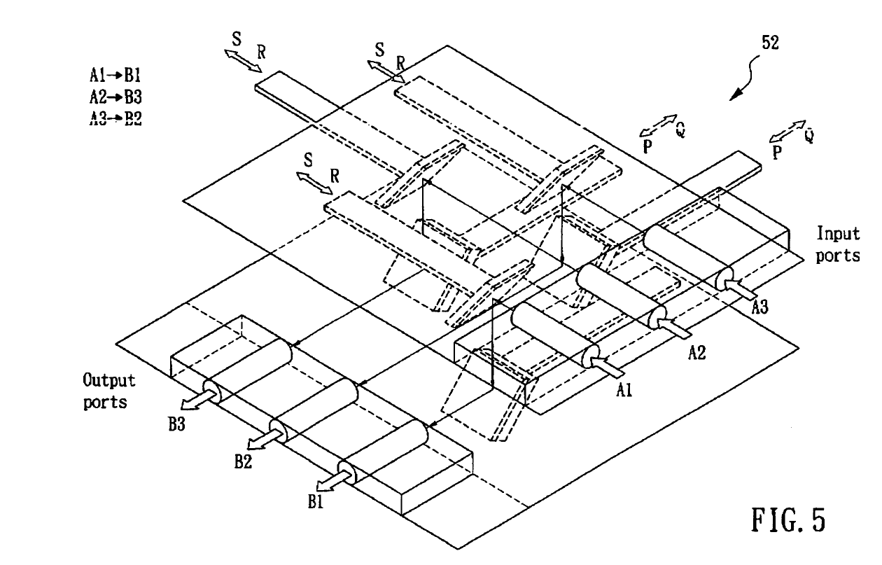

FIG. 5 is a schematic view of the third embodiment of the present invention, showing an array layout composed of a plurality of the optical signal processing apparatus based on movable tilted reflection mirror 42. An array layout of double-layer single reflective movable tilted reflection mirror 52 is provided to combine the function of optical switching and variable optical attenuation in order to execute the optical switch function such as in FIG. 5:

A1→B1, A2→B3, A3→B2

Besides, the position of the reflective mirror plane of each channel can be adjusted so that the function of the optical attenuation can be achieved. Furthermore, the first mode (flat mirror plane) 45, the second mode (shaped mirror plane) 46, and the third mode (curved mirror plane) 47 of the second embodiment all possess the functions of optical switching and variable optical attenuation. Therefore, depending on the variant requirements, all the reflective mirror planes of the array layout of double-layer single reflective movable tilted reflection mirror 52 can be replaced with such three modes.

The aforesaid third embodiment has the following advantages:

1) High revolution

2) Low back reflection loss

3) Simple tuning for orientation after packaged: the details are the same as the second advantage recited in the first embodiment.

4) Higher expansibility: the details are the same as the third advantage recited in the first embodiment.

5) Combing both the functions of optical switching and variable optical attenuation.

The Fourth Embodiment

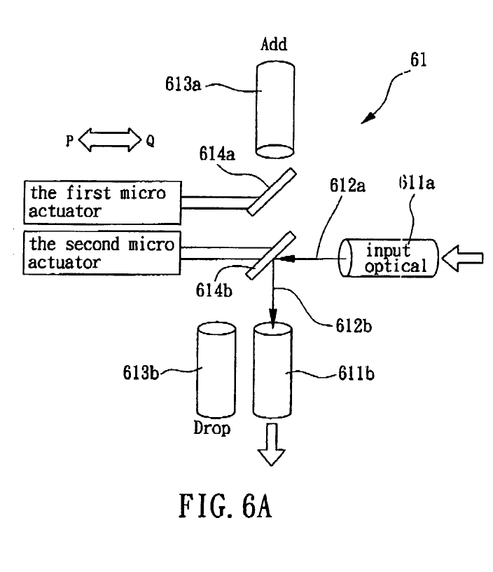

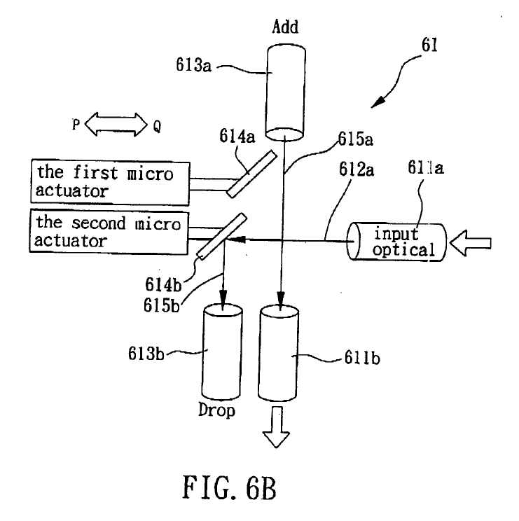

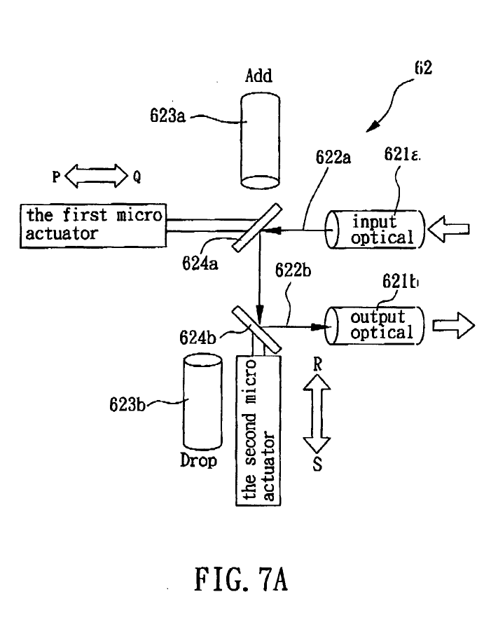

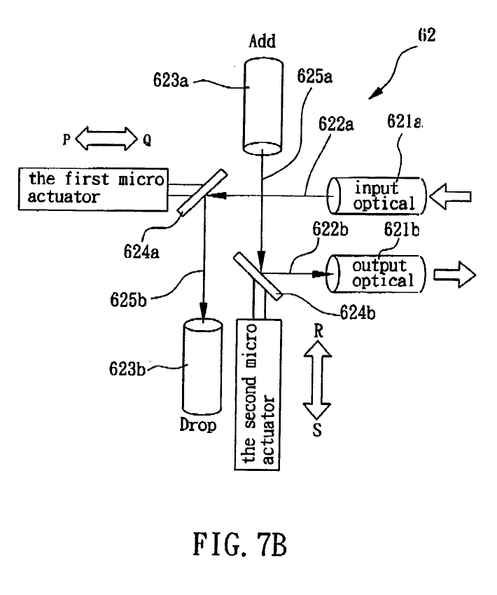

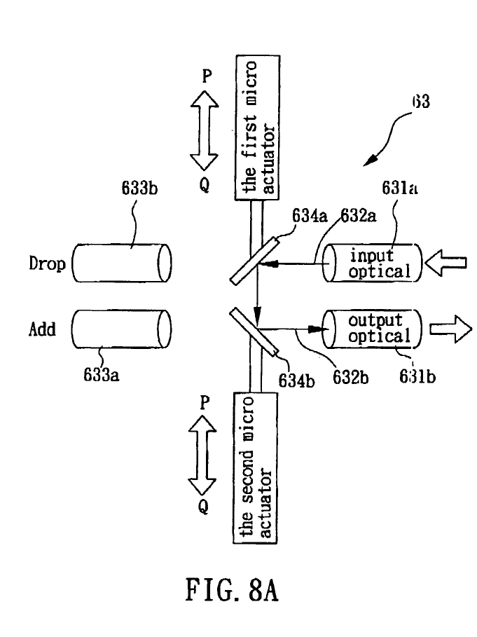

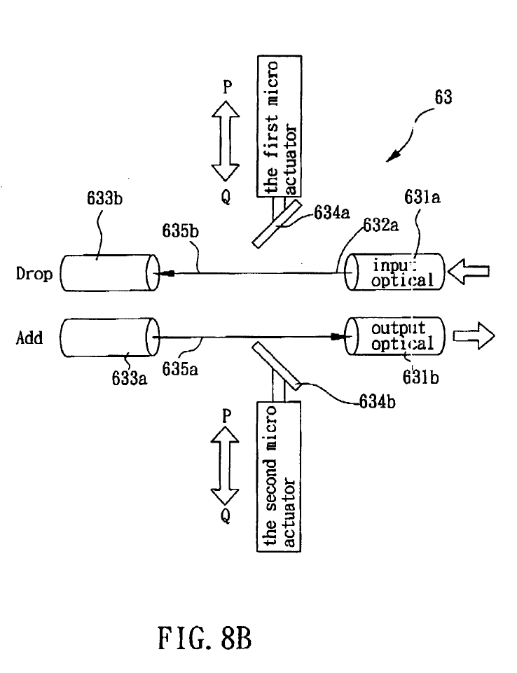

FIGS. 6A as well as 6B, FIGS. 7A as well as 7B, and FIGS. 8A as well as 8B are the schematic views showing respectively the first mode 61, the second mode 62, and the third mode 63 of the fourth embodiment of the present invention. The optical signal processing apparatus based on movable tilted reflection mirror in the fourth embodiment also can be used as an Optical Add/Drop Multiplexer (OADM) with the function of variable optical attenuation.

Please refer to FIGS. 6A and 6B, showing respectively the optical pass state and the optical add/drop state of the first mode in the fourth embodiment. The single reflective optical signal processing apparatus of the first mode 61 includes an input optical signal 612a from an input fiber (or a plane optical waveguide) 611a, an output optical signal 612b from an output fiber (or a plane optical waveguide) 611b, a tributary input 613a, which can add a branch input optical signal 615a (shown in FIG. 6B), a tributary output 613b, which can drop a reflected input optical signal 615b shown in FIG. 6B), a first reflective mirror plane 614a actuated by a first micro actuator, and a second reflective mirror plane 614b actuated by a second micro actuator; wherein, both the first reflective mirror plane 614a and the second reflective mirror plane 614b can move along the direction of PQ.

The major operating states of the first mode the single reflective optical signal processing apparatus 61 can be summarized in Table 1:

TABLE 1

| FIG. | Description of the operating | Operating states |
|---|---|---|
| | 612a is reflected by 614b to become | Pass state |
| | 612b, and then outputted from 611b. | |
| | 615a is outputted from 613a, inputted | |
| | into 611b and then outputted from | |
| | 611b; | |
| | 612a is outputted from 611a, reflected by | Add/Drop state |
| | 614b to become 615b and then | |
| | outputted from 613b. | |

Please refer to FIGS. 7A and 7B, showing respectively the optical pass state and the optical add/drop state of the second mode in the fourth embodiment. The double reflective optical signal processing apparatus of the second mode 62 includes an input optical signal 622a from an input fiber (or a plane optical waveguide) 621a, an output optical signal 622b from an output fiber (or a plane optical waveguide) 621b, a tributary input 623a, which can add a branch input optical signal 625a, a tributary output 623b, which can drop a reflected input optical signal 625b, a first reflective mirror plane 624a actuated by a first micro actuator, and a second reflective mirror plane 624b actuated by a second micro actuator; wherein, both the first reflective mirror plane 624a and the second reflective mirror plane 624b can move along the directions of PQ and RS.

The major operating states of the second mode the double reflective optical signal processing apparatus 62 can be summarized in Table 2:

TABLE 2

| FIG. | Description of the operating | Operating states |
|---|---|---|
| | 622a is reflected respectively by 624a | Pass state |
| | and 624b to become 612b, and then | |
| | outputted from 621b. | |
| | 625a is outputted from 623a, reflected | |
| | by 624b to become 622b and then | |
| | outputted from 621b; | |
| | 622a is outputted from 621a, reflected | Add/Drop state |
| | by 624a to become 625b and then | |
| | outputted from 623b. | |

Please refer to FIGS. 8A and 8B, showing respectively the optical pass state and the optical add/drop state of the third mode in the fourth embodiment. The symmetrical double reflective optical signal processing apparatus of the third mode 63 includes an input optical signal 632a from an input fiber (or a plane optical waveguide) 631a, an output optical signal 632b from an output fiber (or a plane optical waveguide) 631b, a tributary input 633a, which can add a branch input optical signal 635a, a tributary output 633b, which can drop a sub-input optical signal 635b, a first reflective mirror plane 634a actuated by a first micro actuator, and a second reflective mirror plane 634b actuated by a second micro actuator; wherein, both the first reflective mirror plane 634a and the second reflective mirror plane 634b can move along the direction of PQ.

The major operating states of the second mode the double reflective optical signal processing apparatus 63 can be summarized in Table 3:

TABLE 3

| FIG. | Description of the operating | Operating states |
|---|---|---|
| | 632a is reflected respectively by 634a | Pass state |
| | and 634b to become 632b, and then | |
| | outputted from 631b | |
| | 635a is outputted from 633a and then | |
| | outputted from 631b; | |
| | 632a is outputted from 631a to become | Add/Drop state |
| | 635b, and then outputted from 633b. | |

The first mode 71, the second mode 72, and the third mode 73 listed in the above Table 1, 2, 3 are all possess the complete function of OADM. In addition to the disclosed applications of OADM, such three modes also possess the function of variable optical attenuation recited in the third embodiment of the present invention by using at least one micro actuator to actuate the relative reflective mirror plane. Besides, in the add/drop state of the first mode 61 shown in FIG. 6B, the reflective mirror plane 614a can be moved to interrupt, partial interrupt, or pass the branch input optical signal 615a so as to obtain the effect of attenuating the branch input optical signal 615. A plurality of the fourth embodiment in the present invention can be integrated to form an array layout of optical signal processing apparatus with the function of multiple channels processing, which can be used in the optical communication network.

The micro actuator disclosed in the aforesaid variant embodiments of the present invention can be a MEMS electro-thermal actuator, a MEMS electrostatic actuator, a MEMS electromagnetic actuator, a MEMS piezoelectric actuator and so on. Because the said four MEMS actuators are all the prior arts, those skilled in the MEMS should be able to realize and practice readily. To simplify the contents of the present specification, the technologies are not specified in detail as the embodiments.

On arbitrary paths of either the incident optical signal or the reflected optical signal, all the embodiments of the present invention can further comprise some optical elements such as the collimating lens, the collecting lens, the ball lens, the cylindrical lens, the reflective micro lens, the diffraction micro lens like Fresnel lens, and the non-sphere surface lens in order to improve the transmitting rate and the coupling rate of the optical signals, reducing the signal loss in the optical transmission path. Besides, the reflective mirrors of all the embodiments are movable so as to fine tune the positions of the incident optical signals, the positions of the reflected optical signals, or the positions of the incident and the reflected optical signals respectively or simultaneously to obtain the function of variable optical attenuation. In addition, all the reflective mirrors disclosed in the present invention can be fabricated with the silicon microfabrication, the electroplating, the sputtering and so on, and can be replaced by any other optical elements possessing the character of reflectivity such as an optical set comprising variant prisms, variant lens, and variant mirrors. Furthermore, the MEMS reflective units and the micro actuators can be fabricated respectively with the wafer level manufacturing and packaging technology to integrate all the elements into two chips, or with the flip chip technology to integrate the individually fabricated elements into two chips; then the said two chips are connected with each other by the ordinary chip-to-chip bonding technology thus to complete the first level package; further, the completed optical signal processing apparatuses are divided into the several individual; after the optical fiber orientation, fiber seal, and the external package, the whole product will finally be completed. Moreover, all the embodiments of the present invention can be combined to form an array layout of single or multi-channel variable optical attenuators, or an array layout of single or multi-channel optical switches.

In summary, from the structural characteristics and detailed disclosure of each embodiment according to the invention, it sufficiently shows that the invention has progressiveness of deep implementation in both objective and function, also has the application value in industry, and it is an application never seen ever in current market and, according to the spirit of patent law, the invention is completely fulfilled the essential requirement of new typed patent.

What is claimed is:

1. An optical signal processing apparatus based on movable tilted reflection mirror, which includes:
an optical input element;
an optical output element; and
a Micro-Electro-Mechanical system (MEMS) movable tilted reflection mirror unit, comprising at least a reflective mirror plane and a micro actuator connected therewith;
wherein the optical input element, the output element and the MEMS mirror unit are arranged to form an optical transmission path where incident light signals from the optical input element are reflected from the reflective mirror plane toward the optical output element to form a output light, and a reflected light is formed between the reflective mirror plane and the optical output element, intensity of the output light is determined by the percentage of intensity of the reflected light coupled into the optical output element, and the intensity of the reflected light is controlled by the position of the reflective mirror plane that is adjustable according to a value of applied electrical load on the micro actuator.

2. The apparatus for optical signal processing recited in claim 1, wherein the reflective mirror plane further comprises a highly reflective thin film formed on a surface thereof.

3. The apparatus for optical signal processing recited in claim 1, wherein the optical input and output elements can be chosen from the set of optical fibers and optical waveguides.

4. The apparatus for optical signal processing recited in claim 1, wherein the reflective mirror plane can be chosen from the set of a flat mirror plane, a shaped mirror plane, and a curved mirror plane.

5. The apparatus for optical signal processing recited in claim 1, wherein the apparatus further comprises a control unit to provide the functions of variable optical attenuation and optical switching and the control unit can be used in the applications for communication network.

6. The apparatus for optical signal processing recited in claim 1, wherein moving directions oft he reflective mirror plane actuated by the micro actuator are arbitrary directions according to a layout of the optical input element, the optical output element and the Micro-Electro-Mechanical system (MEMS) movable tilted reflection mirror unit.

7. The apparatus for optical signal processing recited in claim 1, wherein the micro actuator can be chosen from the set of MEMS electro-thermal actuators, MEMS electrostatic actuators, MEMS electromagnetic actuators, and MEMS piezoelectric actuators.

8. The apparatus for optical signal processing recited in claim 1, wherein at least one optical element is arranged on the optical transmission path to reduce unwanted optical coupling loss between different elements in the optical transmission path.

9. The apparatus for optical signal processing recited in claim 1, wherein the apparatus is arranged in an array layout for multiple channel applications of variable optical attenuator and optical switch.

10. The apparatus for optical signal processing recited in claim 1, wherein a plurality of the apparatus are integrated to form an optical signal processing apparatus with the multiple channel processing function.

11. The apparatus for optical signal processing recited in claim 1, wherein a plurality of the apparatus are integrated to form an optical signal processing apparatus with the functions of variable optical attenuation, optical switching, optical multiplexing/demultiplexing, and optical add/drop, where the reflective mirror plane is controlled by the micro actuator individually for each MEMS movable tilted reflection mirror unit of each channel of the multiple channels inside the optical signal processing apparatus.
